(19) United States
(12) Patent Application Publication
(10) Pub. No.: US 2016/0073016 A1
(43) Pub. Date: Mar. 10, 2016

(54) SENSOR WITH FOCUS DETECTION UNITS

(71) Applicant: CANON KABUSHIKI KAISHA, Tokyo (JP)

(72) Inventors: Takeru Ohya, Machida-shi (JP); Noriyuki Shikina, Hachioji-shi (JP); Shota Shigemori, Kawasaki-shi (JP)

(21) Appl. No.: 14/838,835

(22) Filed: Aug. 28, 2015

(30) Foreign Application Priority Data
Sep. 5, 2014 (JP) 2014-181593

(51) Int. Cl. H04N 5/232; H04N 9/04; H04N 5/3745

(52) U.S. Cl. CPC H04N 5/23229; H04N 5/3745; H04N 9/045

(57) ABSTRACT

A sensor includes first and second focus detection units. Each of the first and second focus detection units includes a photoelectric converter arranged in a semiconductor substrate, a first light blocking portion arranged in a first layer above the semiconductor substrate, and a second light blocking portion arranged in a second layer above the first layer, orthogonal projection of the photoelectric converter onto a face of the semiconductor substrate has a first end and a second end which are located on opposite sides, orthogonal projection of the first light blocking portion onto the face covers the first end, and orthogonal projection of the second light blocking portion onto the face covers the second end.

### BACKGROUND OF THE INVENTION

1. Field of the Invention

The present invention relates to a sensor and a camera including the sensor.

2. Description of the Related Art

There is provided a pupil-division sensor for obtaining signals for focus detection by separating light beams having passed through different areas of the pupil of an imaging lens by light blocking films provided in pixels. An example of such sensor is a solid state image sensor described in Japanese Patent Laid-Open No. 2009-105358. The solid state image sensor described in Japanese Patent Laid-Open No. 2009-105358 includes pixels for imaging and pixels for focus detection, and a light blocking film is provided in each pixel for focus detection to define light to enter the photoelectric conversion portion of the pixel. This light blocking film is provided in the lowest one of a plurality of metal layers to improve the SN ratio. According to Japanese Patent Laid-Open No. 2009-105358, if a light blocking film is provided in a metal layer far from the photoelectric conversion portion, the amount of light which enters under the light blocking film or enters the photoelectric conversion portion due to multiple reflection between a silicon substrate and the metal layer increases, thereby causing noise.

In a structure in which light beams having passed through different areas of the pupil of an imaging lens are separated by only light blocking films provided in one layer, it is difficult to separate the light beams with high separation performance. It is possible to achieve separation performance to some extent by adjusting the interval between a photoelectric conversion portion and a light blocking film but such design method is limited.

### SUMMARY OF THE INVENTION

The present invention provides a technique advantageous in improving the focus detection accuracy.

One of aspects of the present invention provides a sensor comprising a first focus detection unit and a second focus detection unit, wherein the first focus detection unit includes a first photoelectric converter arranged in a semiconductor substrate, a first light blocking portion arranged in a first layer above the semiconductor substrate, and a second light blocking portion arranged in a second layer above the first layer, orthogonal projection of the first photoelectric converter onto a face of the semiconductor substrate has a first end and a second end which are located on opposite sides, orthogonal projection of the first light blocking portion onto the face covers the first end, and orthogonal projection of the second light blocking portion onto the face covers the second end, and the second focus detection unit includes a second photoelectric converter arranged in the semiconductor substrate, a third light blocking portion arranged in the first layer, and a fourth light blocking portion arranged in the second layer, orthogonal projection of the second photoelectric converter onto the face has a third end and a fourth end which are located on opposite sides, orthogonal projection of the third light blocking portion onto the face covers the third end, and orthogonal projection of the fourth light blocking portion onto the face covers the fourth end.

Further features of the present invention will become apparent from the following description of exemplary embodiments with reference to the attached drawings.

### BRIEF DESCRIPTION OF THE DRAWINGS

FIG. 1 is a block diagram showing a camera according to an embodiment of the present invention;

FIG. 2 is a view showing the schematic arrangement of a solid state image sensor as an embodiment of a sensor according to the present invention;

FIGS. 3A to 3C are cross-sectional views respectively showing the first focus detection unit, second focus detection unit, and imaging pixel of a solid state image sensor according to the first embodiment of the present invention;

FIG. 4 is a view schematically showing the incident angle characteristics of the first focus detection unit and second focus detection unit;

FIGS. 5A to 5F are cross-sectional views for comparing a focus detection unit (comparative example) without the second light blocking portion and a focus detection unit (first embodiment) with the second light blocking portion;

FIG. 6 is a view for explaining an improvement in focus detection accuracy of the solid state image sensor according to the first embodiment of the present invention;

FIGS. 7A and 7B are cross-sectional views respectively showing the first focus detection unit and second focus detection unit of a solid state image sensor according to the second embodiment of the present invention; and

FIGS. 8A and 8B are cross-sectional views respectively showing the first focus detection unit and second focus detection unit of a solid state image sensor according to the third embodiment of the present invention.

### DESCRIPTION OF THE EMBODIMENTS

Exemplary embodiments of the present invention will be described below with reference to the accompanying drawings.

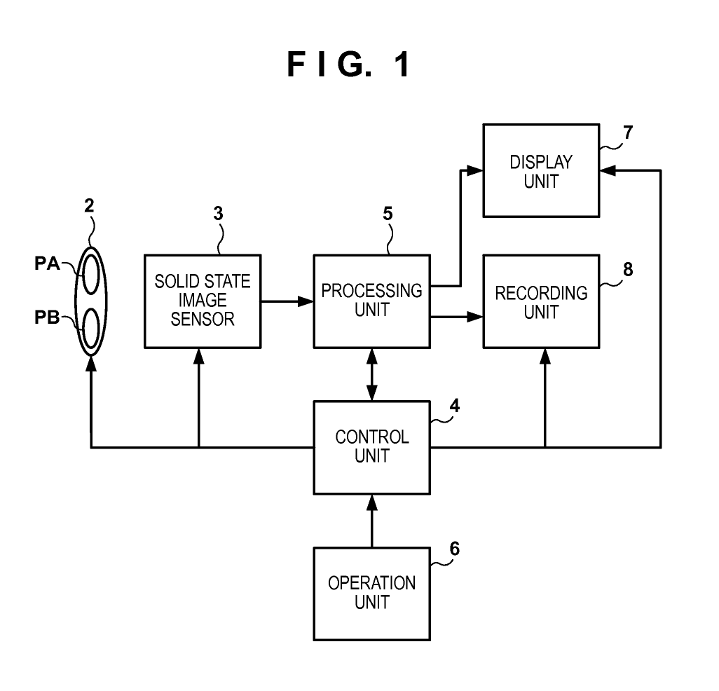

FIG. 1 shows the arrangement of a camera 1 according to an embodiment of the present invention. The camera conceptually includes not only a device whose principal purpose is imaging but also a device (for example, a personal computer or portable terminal) additionally provided with an imaging function. The camera 1 includes, for example, an imaging lens 2, a solid state image sensor 3, a control unit 4, a processing unit 5, an operation unit 6, a display unit 7, and a recording unit 8. The imaging lens 2 is an optical system for forming an image in the imaging region of the solid state image sensor 3.

The solid state image sensor 3 is one embodiment of a sensor according to the present invention. The solid state image sensor 3 has an imaging function and a focus detection function, and outputs focus detection signals and image signals corresponding to an image formed in the imaging region. The focus detection signals are signals of images formed by light beams having passed through different areas PA and PB of the pupil of the imaging lens 2. In addition to processing (for example, development or compression) of the image signals provided from the solid state image sensor 3, the processing unit 5 calculates the defocus amount of the imaging lens 2 based on the focus detection signals provided from the solid state image sensor 3. The control unit 4 controls the imaging lens 2, solid state image sensor 3, processing unit 5, operation unit 6, display unit 7, and recording unit 8. This control processing includes processing of adjusting the focus of the imaging lens 2 based on the defocus amount calculated by the processing unit 5. The operation unit 6 is an interface used by the user to provide a command to the camera 1. The display unit 7 displays a captured image and information about image capturing. The recording unit 8 records a captured image and information attached to it.

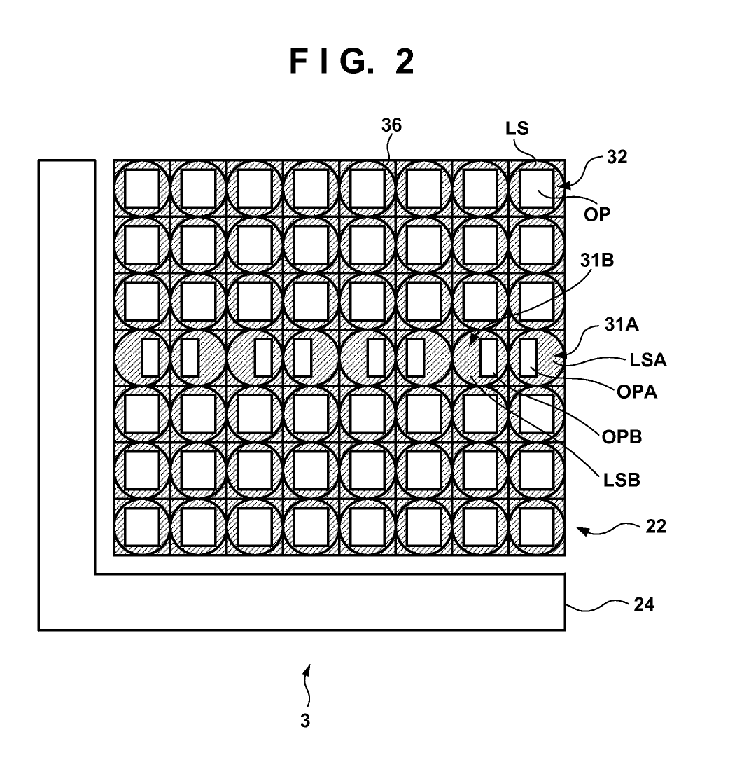

FIG. 2 shows the schematic arrangement of the solid state image sensor 3 as one embodiment of the sensor according to the present invention. The solid state image sensor 3 is, for example, a sensor such as a CMOS image sensor or CCD image sensor. The solid state image sensor 3 includes a pixel array 22 as well as a peripheral circuit 24 for reading out image signals and focus detection signals from the pixel array 22. For example, when the solid state image sensor 3 is formed by a CMOS image sensor, the peripheral circuit 24 can include a vertical scanning circuit, a horizontal scanning circuit, and a processing unit for processing signals from the pixel array.

The solid state image sensor 3 or pixel array 22 includes a plurality of focus detection units 31 including first focus detection units 31A and second focus detection units 31B, and imaging pixels 32. Signals read out from the focus detection units 31 by the peripheral circuit may be used as the signals of pixels forming an image. That is, the focus detection units 31 may be used as pixels. The solid state image sensor 3 may be used as a sensor dedicated for focus detection.

The first focus detection unit 31A detects light having passed through the first area PA of the pupil of the imaging lens 2, and the second focus detection unit 31B detects light having passed through the second area PB of the pupil of the imaging lens 2. The first focus detection unit 31A and second focus detection unit 31B form one detection pair. A plurality of detection pairs are arranged in the pixel array 22. The processing unit 5 calculates the defocus amount of the imaging lens 2 based on a shift between a group of signals (one-dimensional image) detected by the plurality of first focus detection units 31A and a group of signals (one-dimensional image) detected by the plurality of second focus detection units 31B.

Each of the first focus detection units 31A, second focus detection units 31B, and imaging pixels 32 has a microlens 36. In addition, each first focus detection unit 31A includes a light blocking portion LSA with an opening OPA, each second focus detection unit 31B includes a light blocking portion LSB with an opening OPB, and each imaging pixel 32 includes a light blocking portion LS with an opening OP. The opening OPA is configured to allow light having passed through the first area PA of the pupil of the imaging lens 2 to enter the photoelectric converter of the first focus detection unit 31A and to prevent light having passed through the other area of the pupil from entering the photoelectric converter of the first focus detection unit 31A. The opening OPB is configured to allow light having passed through the second area PB of the pupil of the imaging lens 2 to enter the photoelectric converter of the second focus detection unit 31B and to prevent light having passed through the other area of the pupil from entering the photoelectric converter of the second focus detection unit 31B. The opening OP is configured not to block light having passed through the microlens 36 of the imaging pixel 32 as much as possible.

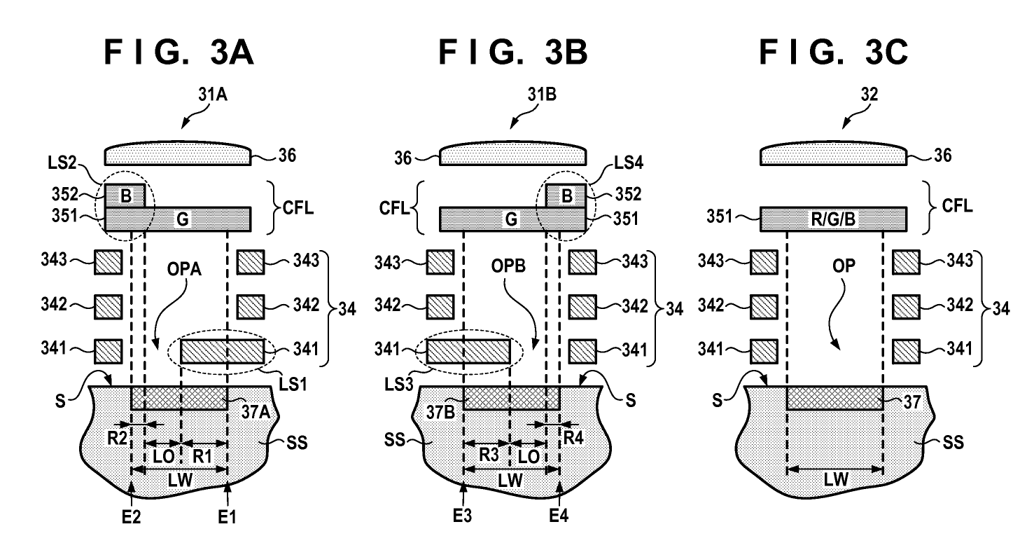

The arrangements of a first focus detection unit 31A, second focus detection unit 31B, imaging pixel 32 in a solid state image sensor 3 according to the first embodiment of the present invention will be described with reference to FIGS. 3A to 3C. FIG. 3A shows the cross-sectional structure of the first focus detection unit 31A. FIG. 3B shows the cross-sectional structure of the second focus detection unit 31B. FIG. 3C shows the cross-sectional structure of the imaging pixel 32. In a pixel array 22, an interconnection structure 34 is arranged above a semiconductor substrate SS, a color filter layer CFL is arranged above the interconnection structure 34, and microlenses 36 are arranged above the color filter layer CFL. The interconnection structure 34 includes a plurality of interconnection layers, that is, a first interconnection layer 341, a second interconnection layer 342, and a third interconnection layer 343. The first interconnection layer 341 is an interconnection layer closest to the semiconductor substrate SS among the first interconnection layer 341, second interconnection layer 342, and third interconnection layer 343. The third interconnection layer 343 is an interconnection layer farthest from the semiconductor substrate SS among the first interconnection layer 341, second interconnection layer 342, and third interconnection layer 343. The first interconnection layer 341, second interconnection layer 342, and third interconnection layer 343 can be formed from a material containing a metal. The first interconnection layer (first layer) 341 preferably includes no light blocking portion whose orthogonal projection onto a face S of the semiconductor substrate SS falls within the region of a third photoelectric converter 37 of the imaging pixel 32. In addition, the color filter layer (second layer) CFL preferably includes no light blocking portion whose orthogonal projection onto the face S of the semiconductor substrate SS falls within the region of the third photoelectric converter 37 of the imaging pixel 32.

The first focus detection unit 31A exemplified in FIG. 3A includes a first photoelectric converter 37A arranged in the semiconductor substrate SS. The first focus detection unit 31A also includes a first light blocking portion LS1 arranged in the first interconnection layer (first layer) 341 on the semiconductor substrate SS, and a second light blocking portion LS2 arranged in the color filter layer (second layer) CFL on the first interconnection layer (first layer) 341. In the cross section shown in FIG. 3A or orthogonal projection onto the face S of the semiconductor substrate SS, the first photoelectric converter 37A has a first end E1 and a second end E2 on the opposite sides. The orthogonal projection of the first light blocking portion LS1 onto the face S covers the first end E1, and the orthogonal projection of the second light blocking portion LS2 onto the face S covers the second end E2. Note that the orthogonal projection of the first photoelectric converter 37A onto the face S includes a region which overlaps neither the orthogonal projection of the first light blocking portion LS1 onto the face S nor that of the second light blocking portion LS2 on the face S. A region R1 where the orthogonal projection of the first light blocking portion LS1 onto the face S overlaps the first photoelectric converter 37A on the face S is larger than a region R2 where the orthogonal projection of the second light blocking portion LS2 onto the face S overlaps the first photoelectric converter 37A on the face S. The orthogonal projection of the first light blocking portion LS1 onto the face S of the semiconductor substrate SS can cover, for example, a portion of ½ the entire first photoelectric converter 37A. In general, the incident angle characteristic depends on the shape of the microlens 36, the distance between the photoelectric converter 37A and the microlens 36, the arrangement of the interconnection layers, the arrangement of the light blocking portions LS1 and LS2, and the like. Particularly, the angle (for example, the angle with respect to the normal set at the center of the first photoelectric converter 37A) of light entering the first photoelectric converter 37A is defined by the first light blocking portion LS1 and the second light blocking portion LS2.

The second focus detection unit 31B exemplified in FIG. 3B includes a second photoelectric converter 37B arranged in the semiconductor substrate SS. The second focus detection unit 31B also includes a third light blocking portion LS3 arranged in the first interconnection layer (first layer) 341 on the semiconductor substrate SS, and a fourth light blocking portion LS4 arranged in the color filter layer (second layer) CFL on the first interconnection layer (first layer) 341. In the cross section shown in FIG. 3B or orthogonal projection onto the face S of the semiconductor substrate SS, the second photoelectric converter 37B has a third end E3 and a fourth end E4 on the opposite sides. The orthogonal projection of the third light blocking portion LS3 onto the face S covers the third end E3, and the orthogonal projection of the fourth light blocking portion LS4 onto the face S covers the fourth end E4. Note that the orthogonal projection of the second photoelectric converter 37B onto the face S includes a region which overlaps neither the orthogonal projection of the third light blocking portion LS3 onto the face S nor that of the fourth light blocking portion LS4 on the face S. A region R3 where the orthogonal projection of the third light blocking portion LS3 onto the face S overlaps the second photoelectric converter 37B on the face S is larger than a region R4 where the orthogonal projection of the fourth light blocking portion LS4 onto the face S overlaps the second photoelectric converter 37B on the face S. The orthogonal projection of the third light blocking portion LS3 onto the face S of the semiconductor substrate SS can cover, for example, a portion of ½ the entire second photoelectric converter 37B. In general, the incident angle characteristic depends on the shape of the microlens 36, the distance between the photoelectric converter 37B and the microlens 36, the arrangement of the interconnection layers, the arrangement of the light blocking portions LS3 and LS4, and the like. Particularly, the angle (for example, the angle with respect to the normal set at the center of the second photoelectric converter 37B) of light entering the second photoelectric converter 37B is defined by the third light blocking portion LS3 and the fourth light blocking portion LS4.

Let LW be the width of each of the photoelectric converters 37A, 37B, and 37, and LO be the width of each of openings OPA and OPB. Then, LO≦(½) LW can hold. Note that if the region R3 and the region R1 in the cross section shown in FIG. 3A are smaller than ½ LW, that relationship need not be satisfied. The first light blocking portion LS1 and the third light blocking portion LS3 need not always be formed in the first interconnection layer 341, and may be formed in another interconnection layer, that is, the second interconnection layer 342 or the third interconnection layer 343.

The imaging pixel 32 exemplified in FIG. 3C includes the interconnection structure 34 forming the light blocking portion LS which defines the opening OP, the color filter layer CFL arranged above the interconnection structure 34, and the microlens 36 arranged above the color filter layer CFL. The imaging pixels 32 include, as a plurality of kinds of pixels provided with color filters 35 of different colors, a pixel provided with a red (R) color filter 35, and a pixel provided with a green (G) color filter 35, and a pixel provided with a blue (B) color filter 35. The red color filter transmits light in the red range, the green color filter transmits light in the green range, and the blue color filter transmits light in the blue range.

The second light blocking portion LS2 of the first focus detection unit 31A can be formed by, for example, a stacked structure of a green (G) color filter 351 and a blue (B) color filter 352. The fourth light blocking portion LS4 of the second focus detection unit 31B can be formed by a stacked structure of the green (G) color filter 351 and the blue (B) color filter 352. That is, the second light blocking portion LS2 and the fourth light blocking portion LS4 which hardly transmit light to function as light blocking films can be formed by stacking the color filters of different colors.

The green color filters 351 of the first focus detection unit 31A and second focus detection unit 31B can be formed from the same material as that of the green color filter 35 of the imaging pixel 32. The blue color filters 352 of the first focus detection unit 31A and second focus detection unit 31B can be formed from the same material as that of the blue color filter 35 of the imaging pixel 32. In the first focus detection unit 31A, the orthogonal projection, onto the face S of the semiconductor substrate SS, of the green (G) color filter 351 which is one of the green (G) color filter 351 and the blue (B) color filter 352 can cover the entire first photoelectric converter 37A. In the second focus detection unit 31B, the orthogonal projection, onto the face S of the semiconductor substrate SS, of the green (G) color filter 351 which is one of the green (G) color filter 351 and the blue (B) color filter 352 can cover the entire second photoelectric converter 37B.

The description of the color filters will be summarized below. The plurality of imaging pixels 32 include pixels with color filters of the first color and pixels with color filters of the second color different from the first color. Each of the second light blocking portion LS2 and the fourth light blocking portion LS4 can be formed by a stacked structure of the color filter of the first color and the color filter of the second color.

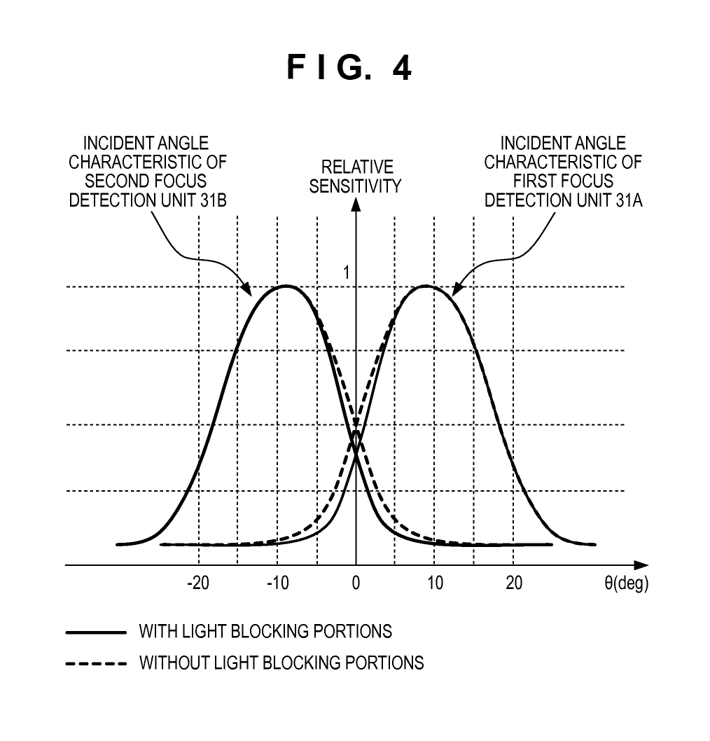

FIG. 4 schematically shows the incident angle characteristics of the first focus detection unit 31A and second focus detection unit 31B. The incident angle characteristic depends on the radius of curvature of the microlens 36, the distance between the microlens 36 and the photoelectric converter 37A or 37B, the arrangement of the light blocking portions LS1 and LS2 or LS3 and LS4, and the like. In FIG. 4, the abscissa represents the incident angle (the angle with respect to the normal to the face S) of light entering the photoelectric converter 37A or 37B. The incident angle of light entering from the right direction is positive (+), and the incident angle of light entering from the left direction is negative (−). In FIG. 4, the ordinate represents relative sensitivity which is normalized by setting the peak value to 1. A curve having a peak on the positive (+) side represents the incident angle characteristic of the first focus detection unit 31A, and a curve having a peak on the negative (−) side represents the incident angle characteristic of the second focus detection unit 31B.

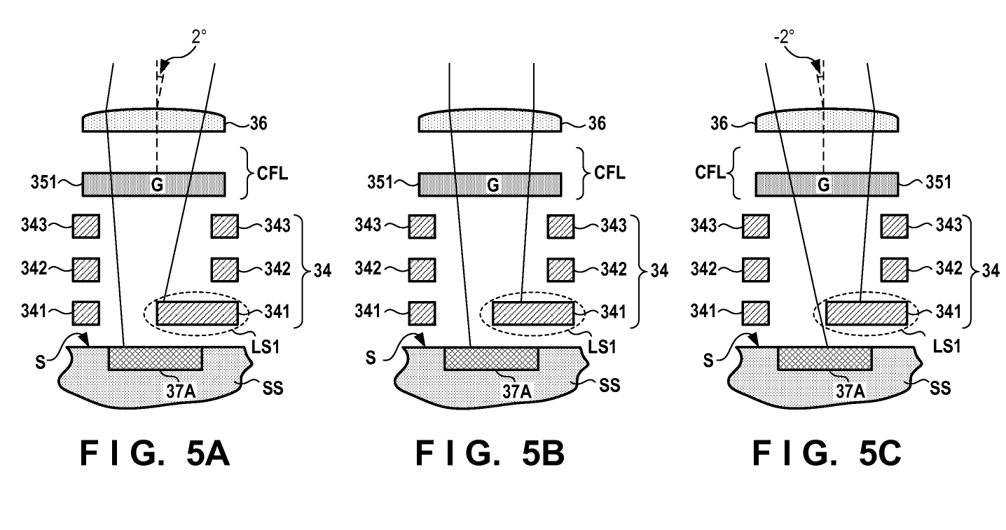

Solid lines shown in FIG. 4 represent the incident angle characteristics of the focus detection units 31A and 31B exemplified in FIGS. 3A and 3B, respectively, and dotted lines represent the incident angle characteristics (comparative examples) of focus detection units having structures in which the light blocking portions LS2 and LS4 are removed from the focus detection units 31A and 31B, respectively. The incident angle characteristic (solid line) of the focus detection unit 31A or 31B having the light blocking portion LS2 or LS4 changes around 0° more abruptly than that of the focus detection unit without the light blocking portion LS2 or LS4. The reason for this will be described with reference to FIGS. 5A to 5F.

FIGS. 5A, 5B, and 5C are cross-sectional views each showing the first focus detection unit without the second light blocking portion LS2. FIG. 5B shows a case in which light vertically enters the face S, FIG. 5A shows a case in which light enters at an angle of +2°, and FIG. 5C shows a case in which light enters at an angle of −2°. In the case shown in FIG. 5B, about 50% of the incident light is blocked by the first light blocking portion LS1, and about 50% of the incident light enters the photoelectric converter 37A. On the other hand, in the case shown in FIG. 5A, about 70% of the incident light enters the photoelectric converter 37A. In the case shown in FIG. 5C, about 30% of the incident light enters the photoelectric converter 37A.

On the other hand, FIGS. 5D, 5E, and 5F are cross-sectional views each showing the first focus detection unit 31A with the second light blocking portion LS2. The second light blocking portion LS2 is arranged at a position close to the microlens 36, and incident light does not converge so much at this position. The ratio of light blocked by the second light blocking portion LS2 to the incent light is almost the same in FIGS. 5D, 5E, and 5F. As an example, assume that left 20% of the incident light is blocked by the second light blocking portion LS2. Considering light blocked by the second light blocking portion LS2 and first light blocking portion LS1, the ratio of light entering the photoelectric converter 37A to the incident light is 50% in the case shown in FIG. 5D, 30% in the case shown in FIG. 5E, and 10% in the case shown in FIG. 5F.

If no second light blocking portion LS2 is included, the ratio between the amount of light entering the photoelectric converter 37A when light enters the microlens 36 at +2° and that of light entering the photoelectric converter 37A when light enters the microlens 36 at −2° is 30%/70%≈43%. On the other hand, if the second light blocking portion LS2 is included, the ratio between the amount of light entering the photoelectric converter 37A when light enters the microlens 36 at +2° and that of light entering the photoelectric converter 37A when light enters the microlens 36 at −2° is 10%/50%=20%. That is, the gradient of the incident angle characteristic around 0° when the second light blocking portion LS2 is included is steeper than that when no second light blocking portion LS2 is included. Note that when the second light blocking portion LS2 is included, the amount of light entering the photoelectric converter 37A decreases at any angle, as compared with the case in which no second light blocking portion LS2 is included, but each incident angle characteristic shown in FIG. 4 is normalized by the peak value, and thus the peaks are equal to each other regardless of whether the second light blocking film is included or not.

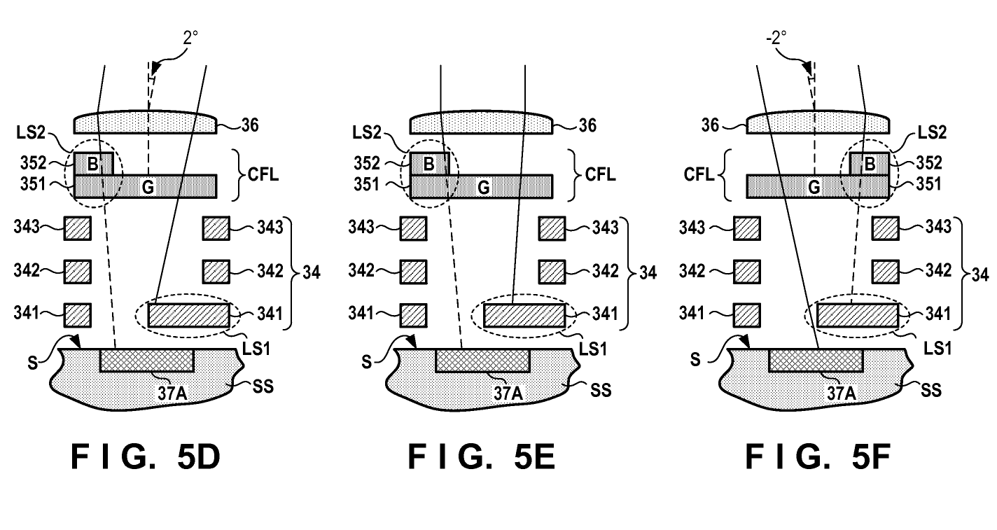

The focus detection accuracy of the solid state image sensor 3 according to the first embodiment of the present invention will be described below with reference to FIG. 6. The incident angle characteristics when the light blocking portions LS2 and LS4 are included and those when the light blocking portions LS2 and LS4 are not included are shown in the upper portion of FIG. 6, similarly to FIG. 4. In an example, when the f-value of the imaging lens 2 is F5.6, light enters pixels near the center of the solid state image sensor 3 at an incident angle of about −5° to +5°. That is, light in a range indicated by A in the incident angle characteristics in the upper portion of FIG. 6 enters the solid state image sensor 3.

Incident angle characteristics obtained by extracting only the range A are shown in the middle portion of FIG. 6. In the incident angle characteristics obtained by extracting only the range A, as the distance between the barycenter of the incident angle characteristic of the first focus detection unit 31A and that of the incident angle characteristic of the second focus detection unit 31B is longer, the focus detection accuracy is higher. Barycentric positions when the light blocking portion LS2 or LS4 are included and those when the light blocking portions LS2 and LS4 are not included are shown in the lower portion of FIG. 6. The incident angle characteristics around 0° when the light blocking portions LS2 and LS4 are included are steeper. Therefore, as the two barycentric positions are farther away from each other, the focus detection accuracy improves.

As described above, according to the first embodiment, by providing the additional light blocking portions LS2 and LS4 in the focus detection units 31A and 31B, respectively, it is possible to improve the separation performance of light beams having passed through different areas of the pupil of the imaging lens, thereby improving the focus detection accuracy.

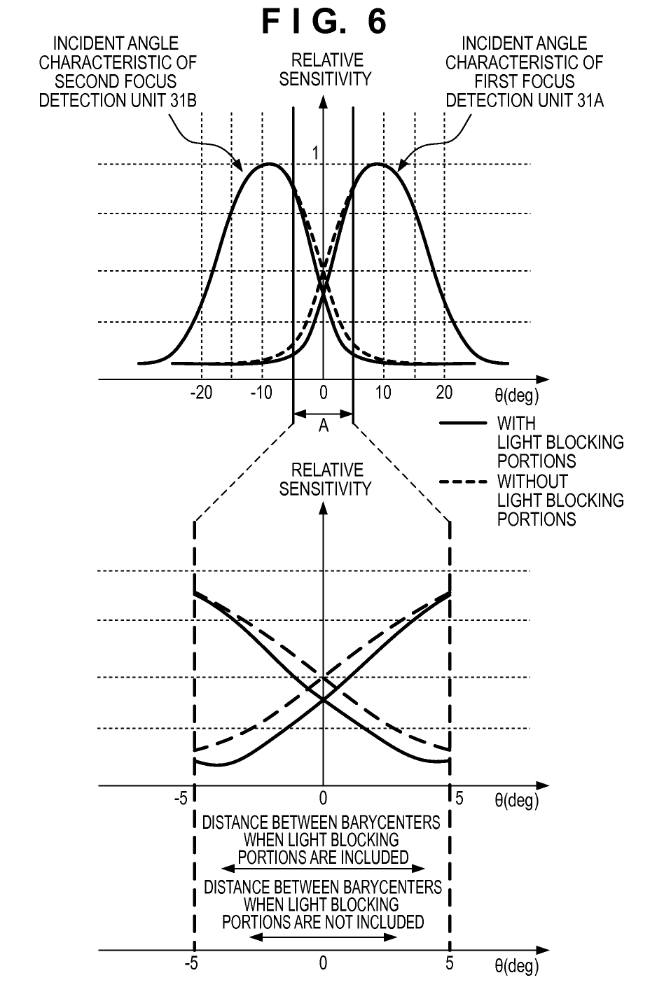

The arrangements of a first focus detection unit 31A and second focus detection unit 31B of a solid state image sensor 3 according to the second embodiment of the present invention will be described below with reference to FIGS. 7A and 7B. Note that details not mentioned in the second embodiment can conform to those in the first embodiment. FIG. 7A shows the cross-sectional structure of the first focus detection unit 31A. FIG. 7B shows the cross-sectional structure of the second focus detection unit 31B. In the second embodiment, the second light blocking portion LS2 and the fourth light blocking portion LS4 are replaced by monolayer color filters. A color filter layer CFL of the first focus detection unit 31A includes a color filter (light attenuation filter) 351 which transmits light to enter a first photoelectric converter 37A, and a color filter 352 forming the second light blocking portion LS2. The color filter layer CFL of the second focus detection unit 31B includes a color filter 351 which transmits light to enter a second photoelectric converter 37B, and a color filter (light attenuation filter) 352 forming the fourth light blocking portion LS4.

The color filter 351 can have the same color as that of the color filter (for example, the green color filter) of one of a plurality of kinds of imaging pixels 32. In other words, the color filter 351 can be formed from the same material as that of the color filter of one of the plurality of kinds of imaging pixels 32. On the other hand, the color filter 352 forming the light blocking portion LS2 or LS4 can be a black or blue color filter. The black color filter indicates a light attenuation filter which attenuates incident light in the entire range and transmits it. The color filter 352 need only have at least a function of attenuating light transmitted through itself, but the attenuation amount is preferably larger.

In general, the number of electrons generated when incident light having a given spectrum passes through a blue color filter to enter a photoelectric converter is smaller than that of electrons generated when the incident light passes through a green color filter to enter the photoelectric converter. Therefore, it is also possible to obtain the same light blocking effect when the light blocking portions LS2 and LS4 are formed by blue color filters.

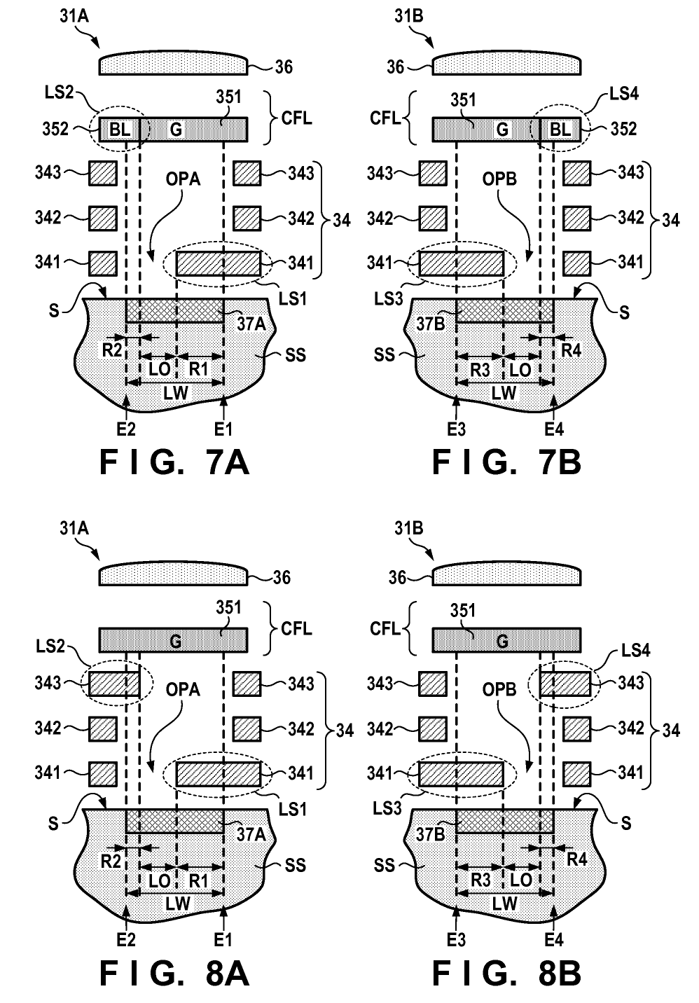

The arrangements of a first focus detection unit 31A and second focus detection unit 31B of a solid state image sensor 3 according to the third embodiment of the present invention will be described below with reference to FIGS. 8A and 8B. Note that details not mentioned in the third embodiment can conform to those in the first embodiment. FIG. 8A shows the cross-sectional structure of the first focus detection unit 31A. FIG. 8B shows the cross-sectional structure of the second focus detection unit 31B. In the third embodiment, the second light blocking portion LS2 and the fourth light blocking portion LS4 according to the first embodiment are formed in an interconnection layer other than a first interconnection layer 341 of an interconnection structure 34, that is, a second interconnection layer 342 or a third interconnection layer 343. Furthermore, a first light blocking portion LS1 and a third light blocking portion LS3 may be arranged in a given interconnection layer of the interconnection structure 34 and a second light blocking portion LS2 and a fourth light blocking portion LS4 may be arranged in another interconnection layer of the interconnection structure 34. In this case, the interconnection layer in which the first light blocking portion LS1 and third light blocking portion LS3 can be arranged between a semiconductor substrate SS and the layer in which the second light blocking portion LS2 and fourth light blocking portion LS4 are arranged.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-181593, filed Sep. 5, 2014, which is hereby incorporated by reference herein in its entirety.

What is claimed is:

1. A sensor comprising a first focus detection unit and a second focus detection unit,
wherein the first focus detection unit includes a first photoelectric converter arranged in a semiconductor substrate, a first light blocking portion arranged in a first layer above the semiconductor substrate, and a second light blocking portion arranged in a second layer above the first layer, orthogonal projection of the first photoelectric converter onto a face of the semiconductor substrate has a first end and a second end which are located on opposite sides, orthogonal projection of the first light blocking portion onto the face covers the first end, and orthogonal projection of the second light blocking portion onto the face covers the second end, and
the second focus detection unit includes a second photoelectric converter arranged in the semiconductor substrate, a third light blocking portion arranged in the first layer, and a fourth light blocking portion arranged in the second layer, orthogonal projection of the second photoelectric converter onto the face has a third end and a fourth end which are located on opposite sides, orthogonal projection of the third light blocking portion onto the face covers the third end, and orthogonal projection of the fourth light blocking portion onto the face covers the fourth end.

2. The sensor according to claim 1, further comprising:
a plurality of imaging pixels each including a third photoelectric converter arranged in the semiconductor substrate.

3. The sensor according to claim 2, wherein no light blocking portion whose orthogonal projection onto the face falls within a region of the third photoelectric converter exists in the second layer.

4. The sensor according to claim 2, wherein no light blocking portion whose orthogonal projection onto the semiconductor substrate falls within a region of the third photoelectric converter exists in the first layer.

5. The sensor according to claim 1, wherein the second light blocking portion and the fourth light blocking portion are formed by color filters.

6. The sensor according to claim 2, wherein
the plurality of imaging pixels include a pixel with a color filter of a first color, and a pixel with a color filter of a second color different from the first color, and
each of the second light blocking portion and the fourth light blocking portion is formed by a stacked structure of the color filter of the first color and the color filter of the second color.

7. The sensor according to claim 6, wherein orthogonal projection, on the face, of one of the color filter of the first color and the color filter of the second color which form the second light blocking portion covers the entirety of the first photoelectric converter, and orthogonal projection, on the face, of one of the color filter of the first color and the color filter of the second color which form the fourth light blocking portion covers the entirety of the second photoelectric converter.

8. The sensor according to claim 1, wherein
the second layer is a layer in which color filters are arranged, and
the second layer includes a color filter configured to transmit light to enter the first photoelectric converter, a color filter forming the second light blocking portion, a color filter configured to transmit light to enter the second photoelectric converter, and a color filter forming the fourth light blocking portion.

9. The sensor according to claim 1, wherein the second layer is formed from a material containing a metal.

10. The sensor according to claim 1, further comprising:
a plurality of interconnection layers,
wherein the first light blocking portion and the third light blocking portion are arranged in an interconnection layer closest to the semiconductor substrate among the plurality of interconnection layers, and the second light blocking portion and the fourth light blocking portion are arranged in an interconnection layer farthest from the semiconductor substrate among the plurality of interconnection layers.

11. The sensor according to claim 1, wherein a region where the orthogonal projection of the first light blocking portion onto the face overlaps the first photoelectric converter is larger than a region where the orthogonal projection of the second light blocking portion onto the face overlaps the first photoelectric converter, and
a region where the orthogonal projection of the third light blocking portion onto the face overlaps the second photoelectric converter is larger than a region where the orthogonal projection of the fourth light blocking portion onto the face overlaps the second photoelectric converter.

12. The sensor according to claim 1, wherein
the orthogonal projection of the first photoelectric converter onto the face includes a region which overlaps neither the orthogonal projection of the first light blocking portion onto the face nor the orthogonal projection of the second light blocking portion onto the face, and
the orthogonal projection of the second photoelectric converter onto the face includes a region which overlaps neither the orthogonal projection of the third light blocking portion onto the face nor the orthogonal projection of the fourth light blocking portion on the face.

13. A camera comprising:
a sensor; and
a processing unit configured to process a signal output from the sensor,
wherein the sensor comprises a first focus detection unit and a second focus detection unit,
the first focus detection unit includes a first photoelectric converter arranged in a semiconductor substrate, a first light blocking portion arranged in a first layer above the semiconductor substrate, and a second light blocking portion arranged in a second layer above the first layer, orthogonal projection of the first photoelectric converter onto a face of the semiconductor substrate has a first end and a second end which are located on opposite sides, orthogonal projection of the first light blocking portion onto the face covers the first end, and orthogonal projection of the second light blocking portion onto the face covers the second end, and
the second focus detection unit includes a second photoelectric converter arranged in the semiconductor substrate, a third light blocking portion arranged in the first layer, and a fourth light blocking portion arranged in the second layer, orthogonal projection of the second photoelectric converter onto the face has a third end and a fourth end which are located on opposite sides, orthogonal projection of the third light blocking portion onto the face covers the third end, and orthogonal projection of the fourth light blocking portion onto the face covers the fourth end.
